(19) United States
(12) Patent Application Publication
(10) Pub. No.: US 2025/0373276 A1
(43) Pub. Date: Dec. 4, 2025

(54) PORTABLE COMMUNICATION ASSEMBLY

(71) Applicant: Interceptor Systems Inc., Beaverlodge (CA)

(72) Inventor: Ryan Evans, Beaverlodge (CA)

(21) Appl. No.: 19/227,076

(22) Filed: Jun. 3, 2025

Related U.S. Application Data
(60) Provisional application No. 63/655,521, filed on Jun. 3, 2024.

(51) Int. Cl. H04B 1/3827; B60P 7/08; H02S 20/30; H02S 30/20

(52) U.S. Cl. CPC H04B 1/3827; B60P 7/08; H02S 20/30; H02S 30/20

(57) ABSTRACT

An apparatus and method for providing a portable communication is disclosed wherein the apparatus comprises a field locatable communication body, at least one deployable leg operable to support the communication body at a location, a selectably extendable mast having a communication transmitter assembly supported from the communication body and at least one selectably deployable solar panel supported from the communication body. The method comprises locating the communication body at a desired location, extending at least one deployable leg from the communication body into contact with a supporting ground surface so as to support the communication body, a selectably extendable mast having a communication transmitter assembly supported from the communication body and a selectably deployable solar panel supported from the communication body.

### BACKGROUND

### 1. Technical Field

This disclosure relates generally to communication assemblies and in particular to a method and apparatus for providing a light weight, rapidly deployable wireless transmission device operable to be deployed at remote locations.

### 2. Description of Related Art

In many remote or difficult to access locations it is frequently difficult to establish effective and reliable communication. In particular, cellular coverage at such remote locations is frequently difficult or limited due to the lack of permanent cellular towers and transmitters. In such locations, one satellite telephones may be frequently used, however such services may be expensive and unreliable.

### SUMMARY OF THE DISCLOSURE

According to a first embodiment, there is disclosed a portable communication assembly comprising a field locatable communication body, at least one deployable leg operable to support the communication body at a location, a selectably extendable mast having a communication transmitter assembly supported from the communication body and at least one selectably deployable solar panel supported from the communication body.

The apparatus may further comprise a towable vehicle operably couplable to the communication body to support the communication body thereon. The towable vehicle may comprise a trailer. The communication body may be connectable to the trailer with trailer connectors. The trailer connectors may be selected from the group consisting of latches and fasteners.

The apparatus may be sized and formed of materials selected to have a weight liftable by a helicopter. The apparatus may further comprise lifting anchor points for suspension from a helicopter.

The at least one deployable leg may comprise a plurality of deployable legs. The deployable legs may be located proximate to each of four corners of the field locatable body. The deployable legs may be pivotally supported by the communication body. The deployable legs may be arranged in opposed pairs at each end of the communication body.

Each opposed pair of deployable legs may be extended from the communication body by a common actuator. The common actuator may be coupled to each of the opposed pair of deployable legs to rotate each deployable leg from a retracted to an extended position in contact with a supporting ground surface. Each of the at least one deployable leg may include an adjustable height foot at a distal end thereof.

The mast may be rotatably supported on the communication body. The mast may include a mast actuator operable to rotate the mast from a stored orientation to a substantially vertical orientation.

The at least one solar panel may include a panel support frame supporting the at solar panel wherein the panel support frame is pivotally supported on the communication body. The panel support frame may include a central frame and at least one wing frame operable supporting a foldable wing panel. The wing panels may be foldably extendable from a central panel so as to unfold at least one side panel from a stowed configuration parallel to and stacked with the central panel to an extended configuration substantially co-planar therewith.

The panel support frame may be rotatable about a pivot on the communication body from a stored horizontal position to a raised angular position. The panel support frame may be movable by a panel actuator. The apparatus may further comprise a controller operable to control the operation of one or more of the actuators associated with the apparatus.

According to a first embodiment, there is disclosed a method for providing a portable communication assembly comprising locating communication body at a desired location, extending at least one deployable leg from the communication body into contact with a supporting ground surface so as to support the communication body, a selectably extendable mast having a communication transmitter assembly supported from the communication body and a selectably deployable solar panel supported from the communication body.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of a portable communication device according to a first embodiment of the present disclosure in an extended configuration.

FIG. 2 is a perspective view of the portable communication device of FIG. 1 in a retracted or transportation configuration.

FIG. 3 is a perspective view of the portable communication device of FIG. 1 in a retracted or transportation configuration.

FIG. 4 is a detailed view of a foot at the end of a leg of the apparatus of FIG. 1.

FIG. 5 is a detailed view of a leg interlock of the apparatus of FIG. 1.

FIG. 6 is a detailed view of a leg interlock of the apparatus of FIG. 1.

FIG. 7 is a perspective view of the apparatus of FIG. 1 at an extended position.

FIG. 8 is a detailed view of a lift mechanism for the solar panel assembly of the apparatus of FIG. 1.

FIG. 9 is a detailed view of a hinge between solar panels of the apparatus of FIG. 1.

FIG. 10 is a rear view of a solar panel assembly of the apparatus of FIG. 1 with additional extended panels.

FIG. 11 is a detailed view of a lift mechanism for the transmitter mast of the apparatus of FIG. 1.

FIG. 12 is an schematic view of an electrical control system for use on the apparatus of FIG. 1.

FIG. 13 is a schematic view of a temperature control system for use on the apparatus of FIG. 1.

FIG. 14 is a detailed view of one of the legs and actuator of the apparatus of FIG. 1 according to a further embodiment.

### DETAILED DESCRIPTION

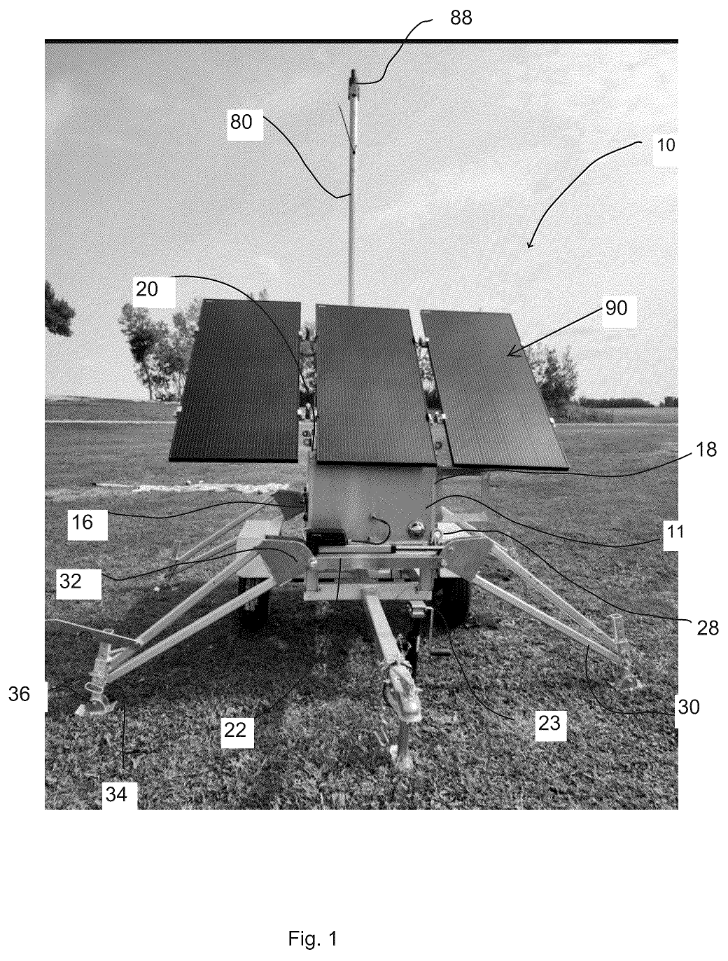

Aspects of the present disclosure are now described with reference to exemplary apparatuses, methods and systems. Referring to FIG. 1, an exemplary apparatus for providing communication services at a location according to a first embodiment is shown generally at 10. The apparatus 10 comprises a body 11 having at least one deployable leg 30, a selectably extendable mast 80 and a selectably deployable solar panel assembly 90.

The communication body 11 may be of any suitable size and shape as required to contain any of the one or more control systems, batteries or the like as are required. The body 11 extends between leading and trailing ends, 12 and 14, respectively, first and second sides, 16 and 18, respectively and a top and bottom surface, 20 and 22, respectively. As illustrated in FIG. 1, the body 10 may be rectangular although it will be appreciated that other shapes may be utilized as well. The body 11 may optionally include a trailer 23 having wheels 24 and/or a towing tongue 26 extending from the leading end 12 for local transportation. In particular the trailer 23 may be sized to receive the body 11 thereon through the use of bolts, quick release pins (not shown) or any other suitable means. Such bolts or pins may for example be passable through tabs or ears extending from one of the body 11 or trailer 23 to secure the two together. The body 11 may include one or more lifting eyes 28 for lifting the body with a crane, helicopter or the like.

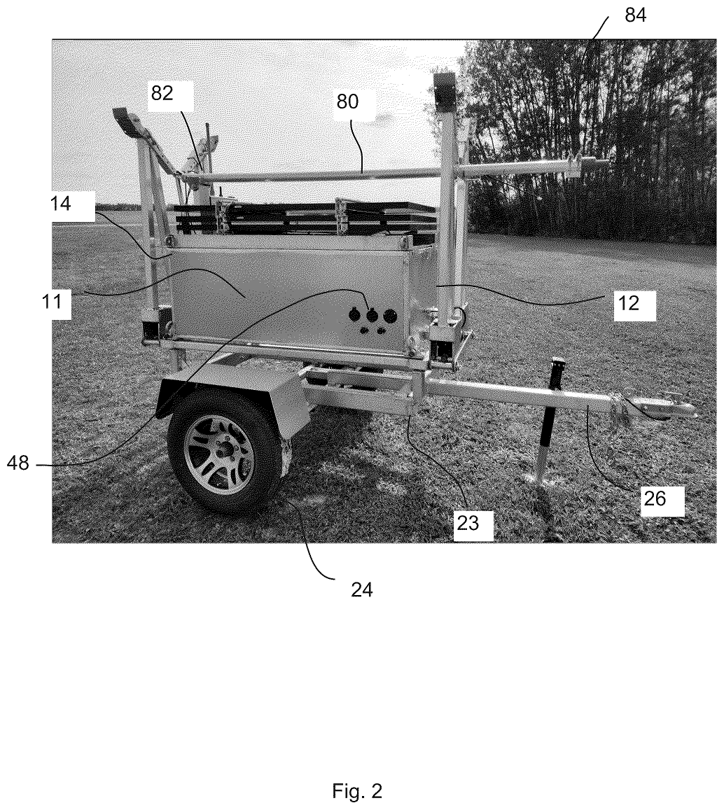

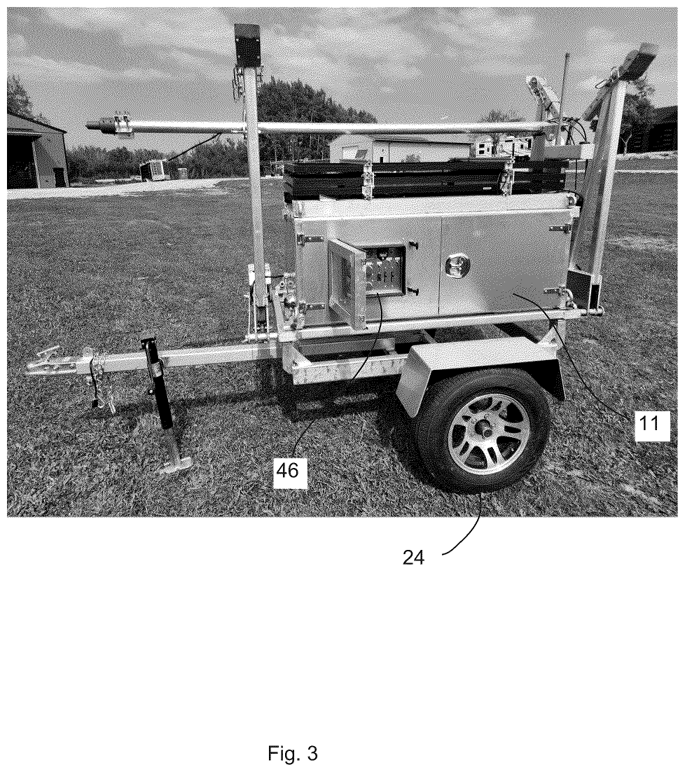

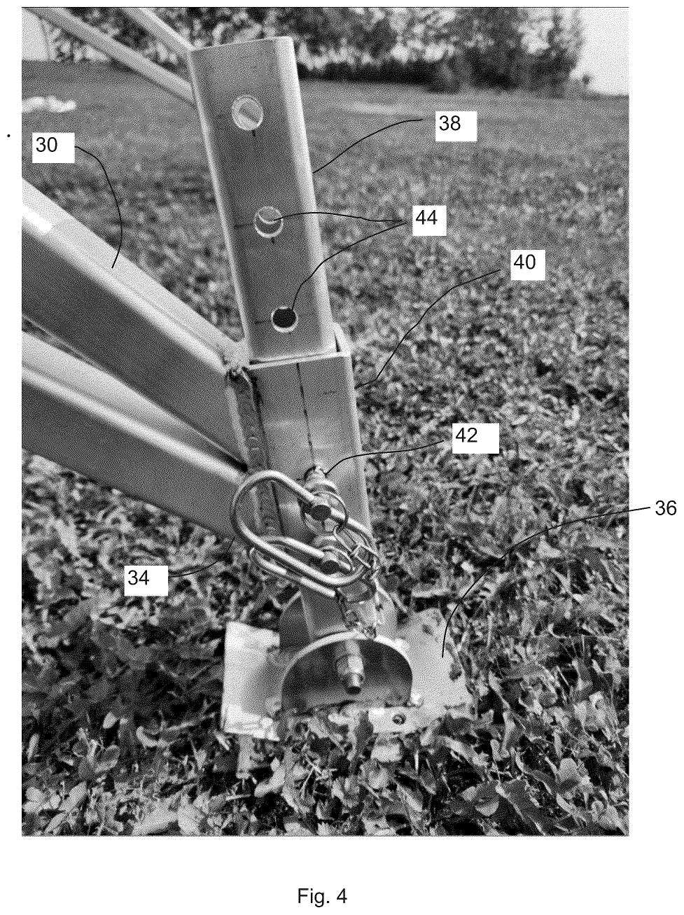

As illustrated, the body 11 may include a leg 30 at each corner thereof adapted to be rotated from a retracted position illustrated in FIG. 1 to an extended position shown in FIGS. 2 and 3. In particular as illustrated, the body 10 may include two pairs of legs 30 arranged in opposed pairs from each other. Each of the legs 30 extends between a proximate and distal end, 32 and 34, respectively wherein the proximate end 32 is pivotally attached to the body 11. It will be appreciated that the pivot may be provided by a pin, hinge or the like. Each distal end 34 may include a foot 36 as illustrated in FIG. 4. Each foot 36 may optionally be connected to an adjustable post 38 received within a sleeve 40 in the distal end of the leg. The adjustable post 38 may be secured within the post 40 by one or more pins 42 passing through bores 44 in the adjustable post and sleeve.

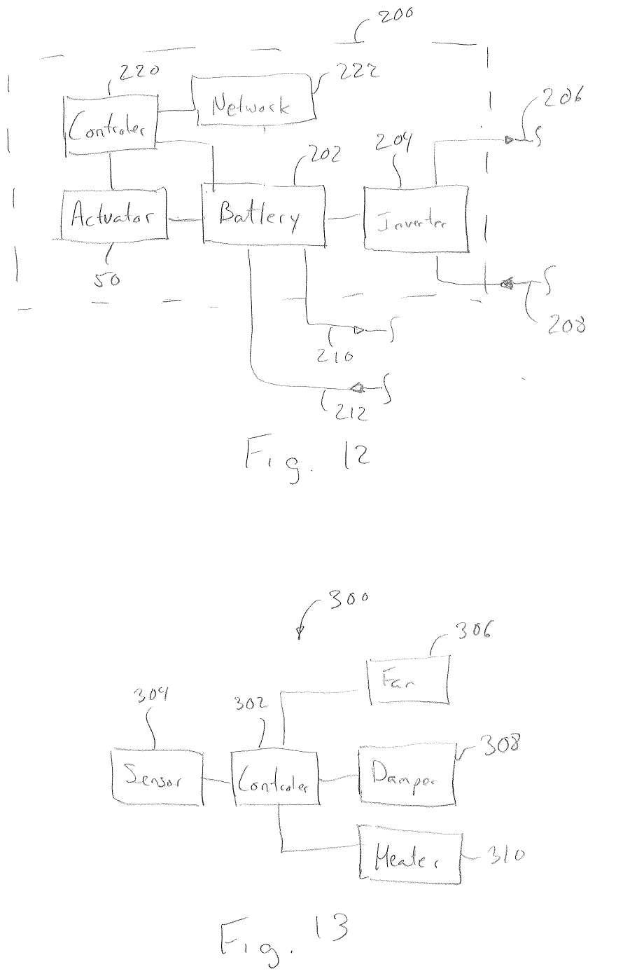

As illustrated in FIGS. 2 and 3, the body 10 may include a control panel 46 and one or more input or output ports 48 for receiving a power input and/or output in any format including direct current or alternating current. In particular, it will be appreciated that inputs both into and out of the body 10 permit the apparatus to be utilized to provide power to an external source. In particular, as illustrated in FIG. 12, the battery system 200 may include a battery 202 with an optional inverter 204. The inverter is operable to both receive an alternating power input 208 and produce an alternating current output 206. Optionally the batter may provide a direct current output 210 and/or input 212. The actuators 50 may also be provided power from the battery as controlled by a controller 220 which is also operably coupled to a network interface 222. It will be appreciated that the network controller 222 may permit the actuators 50 to be extended remotely, including through any known communication means from a user to the apparatus as well as permit remote monitoring of the apparatus.

With reference to FIG. 1, each pair of legs 30 includes an actuator 50 extending therebetween. The actuator 50 may be a linear actuator such as, electric, pneumatic or any other actuator type. In particular each actuator 50 extends between both of the pair of legs so as to extend both legs at the same time. The actuator 50 is selected to have be operable to rotate each of the attached legs 30 may to a limited angle corresponding to the fully extended position as show such as, by way of non-limiting example 180 degrees each. Furthermore, as one actuator 50 is secured to two opposing legs 30, the actuator will be operable to apply an equal rotating to each leg such that in combination with the centralized weight of the body the legs will rotate to an equal degree and keep the body substantially level. Optionally, as illustrated in FIG. 14 the first end 32 may be formed of a bracket 31 spacing first and second leg members apart. The bracket may include a slot 35 extending between first and second ends 33 and 37, respectively. The first end is closer to the pivot point 29 of the leg while the second end 37 is both further from the pivot point and the actuator. In operation, as the actuator pushes each leg out a connection point of the actuator within the slot will move from the first end where the leg is rotated quickly but with less force to the second end where the leg is rotated with more force. This will allow faster deployment while the legs are not engaged on the ground but also greater force multiplication on the legs and therefore a potentially smaller sized actuator.

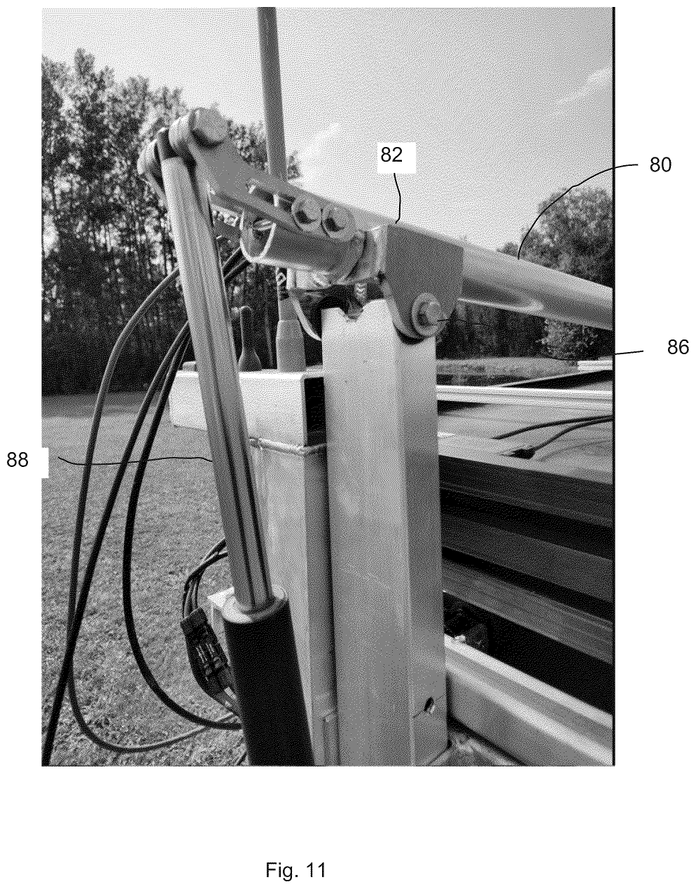

The body 11 includes a mast 80 extending between proximate and distal ends, 82 and 84, respectively. The proximate end 82 is pivotally connected to the body 11 at a pivot, such as by way of non-limiting example, a pin 86 or the like. As illustrated, the pivot may be connected to the body 11 itself or a bracket spacing it above the body as illustrated. The mast includes an actuator 88 as illustrated in FIG. 11 operable to raise the mast 80 from the stored position shown in FIG. 2 to the extended position shown in FIG. 1. The distal end 84 of the mast 80 includes one or more transmitters or receivers 88. It will be appreciated that the transmitters or receivers are adapted to send or receive communication signals from a user for transmission across a network in communication with a network interface 222. Examples of such networks may include cellular, Wi-Fi, satellite, radio transmission, wired or wireless transmission protocols or the like. It will be appreciated that such networks may include an incoming portion and/or an outgoing portion and may include combinations thereof, such as by way of non-limiting example a satellite transmitter receiver combined with a localized wifi or cellular communication to provide communication services over a localized area through the common satellite uplink.

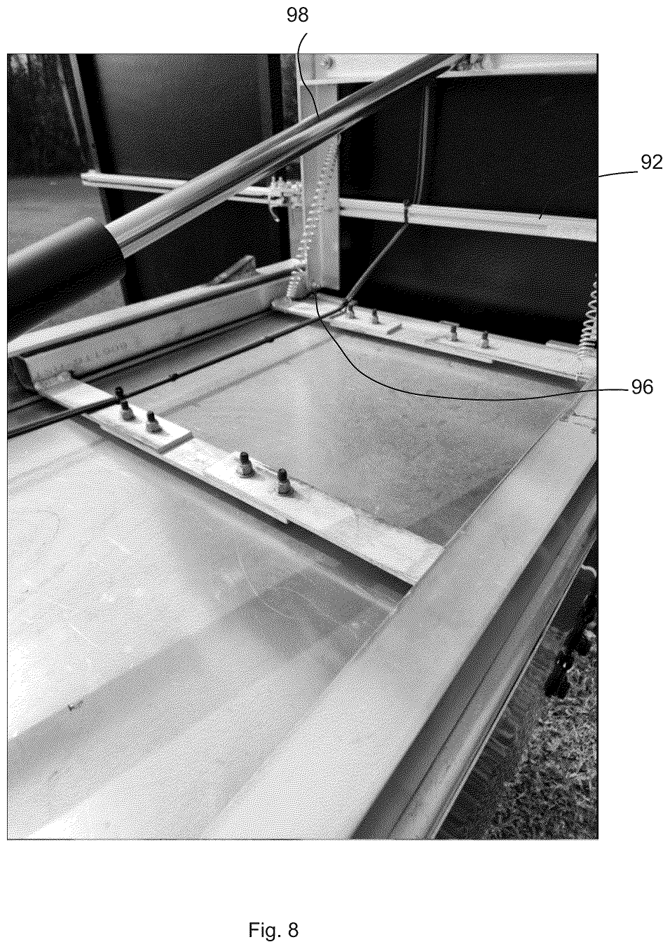

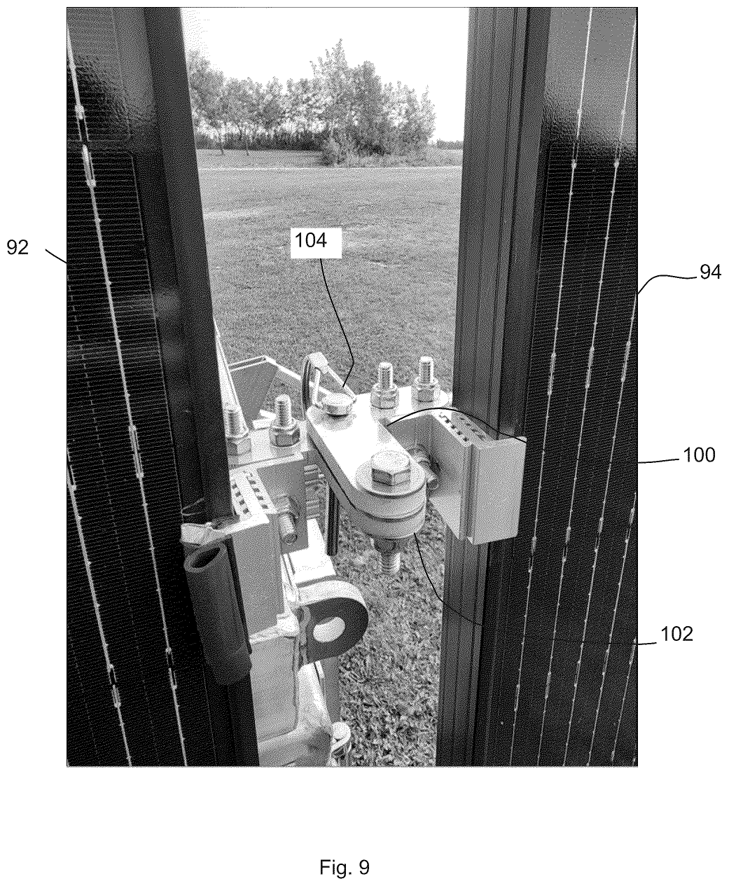

The solar panel assembly 90 may be pivotally connected to each other and or deployed from the body 11 as illustrated in FIGS. 1 and 2. In particular, the solar panel assembly may include a central panel 92 on a central frame 93 and one or more side panels 94 on a side frame 95. The central panel or frame may be pivotally connected to the body 11 about a horizontal pivot axis (96 illustrated in FIGS. 8) so as to be rotatable form a position proximate to the top surface 20 of the body as illustrated in FIGS. 2 and 3 and an angularly inclined position as illustrated in FIG. 1. The side panels or frame may be hinged to the central panel or frame so as to be rotatable between a position substantially co-planar therewith to a position proximate to or stacked thereon as illustrated in FIG. 2. As illustrated in FIG. 8, the central panel 92 may include a linear actuator 98 adapted to raise the central panel 92 from the stored to the raised position. Turning now to FIG. 9, the side panel 94 may be connected to the central panel 92 with a hinge 100. Each hinge 100 may include a pivot 102 extending along an axis parallel to the panels and a spaced apart pin adapted to secure the panels 94 and 92 to the parallel orientation.

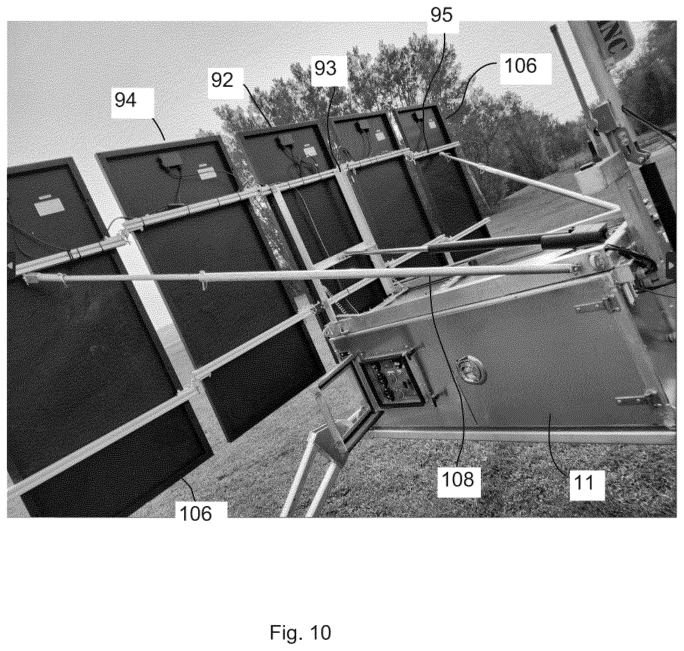

As illustrated in FIG. 10, the solar panel assembly 90 may optionally include additional panels 106 connectable to the side panels so as to be substantially co-planar therewith. The additional panels 106 may be secured to the side panels 94 with hinges 100 similar to those between the side panels 94 and central panel 92 or with simple hinges or pins. The additional panels 106 or side panels 94 may also be supported to their raised position by braces 108 extending from the body 11.

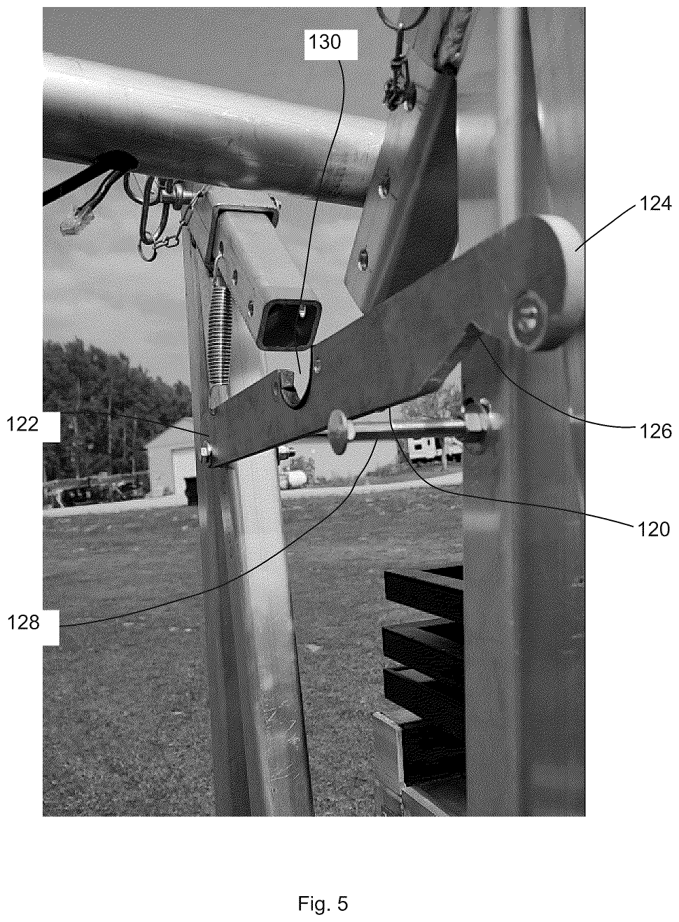

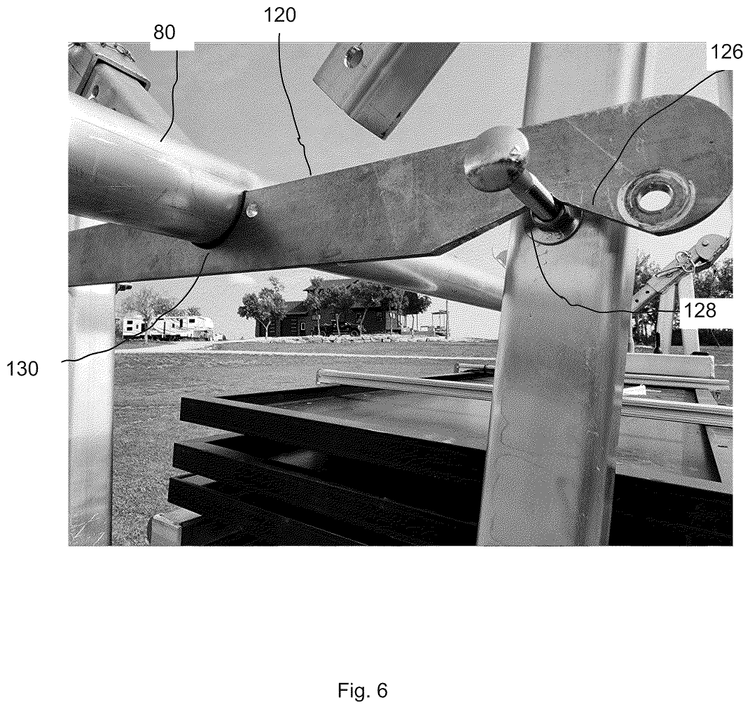

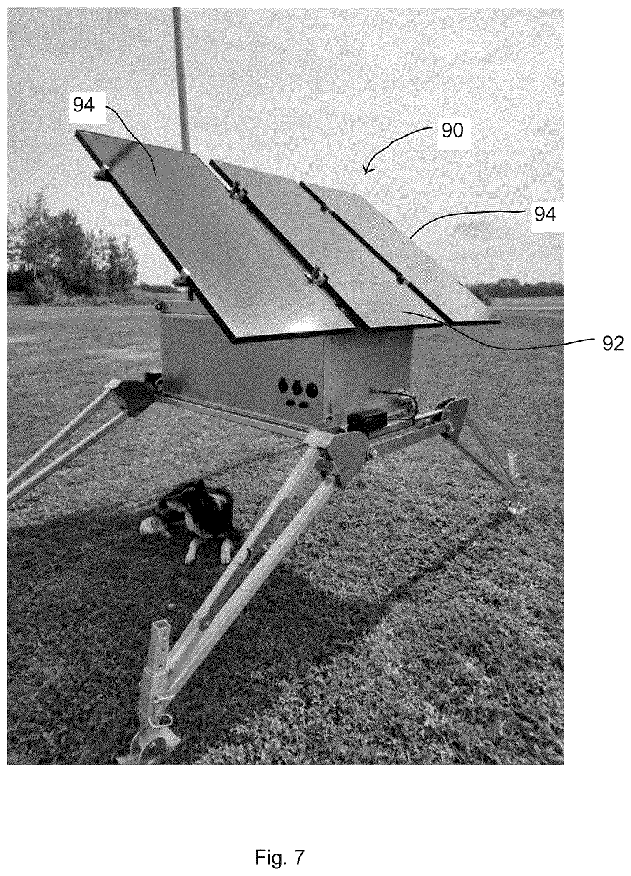

Turning now to FIGS. 4 and 5, one or more of the pair of legs 30 may include an interlock arm 120. The interlock arm 120 extends between proximate and distal ends, 122 and 124 and may be pivotally connected to one leg at the proximate end thereof. The distal end 124 includes a notch 126 in a bottom surface thereof adapted to be aligned with a pin 128 extending from the paired leg 30. The notch is adapted to engage on the pin 128 so as to secure the pair of legs together until raised. The arm may optionally be raised by a user prior to deploying the legs. Optionally, the interlock arm 120 may include a spring extending from the first leg 30 being adapted to lift the interlock arm so as to disengage the notch 126 from the pin. The mast 80 may be adapted to retain the interlock arm 120 in the locked position until lifted away therefrom. Optionally, the interlock arm 120 may include a guide notch 130 adapted to receive and position the mast thereon.

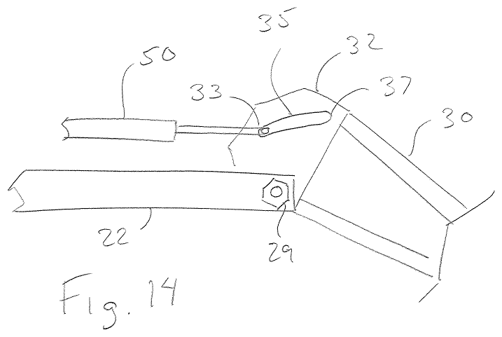

Turning now to FIG. 13, the body may optionally include a temperature control system 300 comprising a controller 302 coupled to a sensor 304 operable to measure the temperature within the body. The system may further include one or more of a fan 306, a damper 308 and/or a heater 310 all adapted and controlled by the controller to maintain the temperature within the body within a desired operating temperature.

While specific embodiments have been described and illustrated, such embodiments should be considered illustrative only and not as limiting the disclosure as construed in accordance with the accompanying claims.

What is claimed is:

1. A portable communication assembly comprising:
a field locatable communication body;
at least one deployable leg operable to support the communication body at a location;
a selectably extendable mast having a communication transmitter assembly supported from the communication body; and
at least one selectably deployable solar panel supported from the communication body.

2. The apparatus of claim 1 further comprising a towable vehicle operably couplable to the communication body to support the communication body thereon.

3. The apparatus of claim 2 wherein the towable vehicle comprises a trailer.

4. The apparatus of claim 3 wherein the communication body is connectable to the trailer with trailer connectors.

5. The apparatus of claim 4 wherein the trailer connectors are selected from the group consisting of latches and fasteners.

6. The apparatus of claim 1 wherein the apparatus is sized and formed of materials selected to have a weight liftable by a helicopter.

7. The apparatus of claim 6 further comprising lifting anchor points for suspension from a helicopter.

8. The apparatus of claim 1 wherein the at least one deployable leg comprises a plurality of deployable legs.

9. The apparatus of claim 8 wherein the deployable legs are located proximate to each of four corners of the field locatable body.

10. The apparatus of claim 8 wherein the deployable legs are pivotally supported by the communication body.

11. The apparatus of claim 8 wherein the deployable legs are arranged in opposed pairs at each end of the communication body.

12. The apparatus of claim 11 wherein each opposed pair of deployable legs are extended from the communication body by a common actuator.

13. The apparatus of claim 12 wherein the common actuator is coupled to each of the opposed pair of deployable legs to rotate each deployable leg from a retracted to an extended position in contact with a supporting ground surface.

14. The apparatus of claim 1 wherein each of the at least one deployable leg includes an adjustable height foot at a distal end thereof.

15. The apparatus of claim 1 wherein the mast is rotatably supported on the communication body.

16. The apparatus of claim 15 wherein the mast includes a mast actuator operable to rotate the mast from a stored orientation to a substantially vertical orientation.

17. The apparatus of claim 1 wherein the at least one solar panel includes a panel support frame supporting the at solar panel wherein the panel support frame is pivotally supported on the communication body.

18. The apparatus of claim 17 wherein the panel support frame includes a central frame and at least one wing frame operable supporting a foldable wing panel.

19. The apparatus of claim 18 wherein the wing panels is foldably extendable from a central panel so as to unfold at least one side panel from a stowed configuration parallel to and stacked with the central panel to an extended configuration substantially co-planar therewith.

20. The apparatus of claim 19 wherein the panel support frame is rotatable about a pivot on the communication body from a stored horizontal position to a raised angular position.

21. The apparatus of claim 17 wherein the panel support frame is movable by a panel actuator.

22. The apparatus of claim 21 further comprising a controller operable to control the operation of one or more of the actuators associated with the apparatus.

23. A method for providing a portable communication assembly comprising:
locating communication body at a desired location;
extending at least one deployable leg from the communication body into contact with a supporting ground surface so as to support the communication body;
a selectably extendable mast having a communication transmitter assembly supported from the communication body; and
a selectably deployable solar panel supported from the communication body.
